(19) United States
(12) Patent Application Publication
(10) Pub. No.: US 2011/0231781 A1
(43) Pub. Date: Sep. 22, 2011

(54) SYSTEM AND METHOD FOR VIRTUAL OBJECT SHARING AND MANAGEMENT IN VIRTUAL WORLDS

(75) Inventors: Boas Betzler, Magstadt (DE); Neil A. Katz, Parkland, FL (US); Gang Wang, Beijing (CN); Meng Ye, Beijing (CN); Zi Yu Zhu, Beijing (CN)

(73) Assignee: INTERNATIONAL BUSINESS MACHINES CORPORATION, Armonk, NY (US)

(21) Appl. No.: 12/727,839

(22) Filed: Mar. 19, 2010

(51) Int. Cl. G06F 15/16; G06F 3/048; G06F 12/08

(52) U.S. Cl. 715/757; 709/206; 711/118; 711/E12.017

(57) ABSTRACT

A system, method, and program storage device for sharing and exchanging virtual objects from different virtual worlds are disclosed. Virtual objects are centrally managed by an inventory service. The inventory service performs data transmission related to virtual objects and data translation related to virtual objects. The inventory service has a repository for storing virtual objects and applies cache policy(s) to local cache memories in virtual worlds to maintain data consistency across the virtual worlds. Based on a publish/subscribe mechanism, each virtual world publishes and subscribes topic notifications related shared virtual objects. The system, method and program storage device are also used for a separate state management of a shared/exchanged virtual object within identical virtual world(s).

### BACKGROUND OF THE INVENTION

1. Field of the Invention

The present invention generally relates to a computer-based virtual world. More particularly, the present invention relates to sharing and exchanging virtual objects (e.g., avatar, virtual assets associated with the avatar) across different virtual worlds.

2. Description of the Prior Art

A virtual world is a computer-based simulated environment intended for its users to inhabit and interact via avatars (from Wikipedia; http://en.wikipedia.org/wiki/Virtual_world; Access date: Oct. 24, 2008). As virtual worlds (e.g., SecondLife®, Active Worlds, MetaVerse) become more and more popular, it is desirable that different virtual worlds interoperate and enables users to “teleport” between different virtual worlds freely. “Teleport”, in a virtual world environment, whether 2D or 3D implementations, means a movement of a player's virtual figure (e.g., Avatar) or virtual assets associated with the avatar from one virtual world to another virtual world, more or less instantaneously. A teleport action may span across different virtual worlds other than the same virtual world. For example, a user may teleport between virtual worlds provided by different vendors (Forterra, Linden Lab Second Life®, ActiveWorld etc.) or between virtual world instances of the same vendor. Technically, the teleport involves data transmission of virtual assets (teleport within the same virtual world on the same physical server devices) or bulk data transmission (teleport between different virtual worlds on distributed physical server devices). After teleport, a player's computer screen may change to reflect a result of teleportation, and render new scenes (i.e., a scene is a virtual environment where a virtual asset resides in). In addition, a state of the player's avatar including the virtual assets in the inventory, a state for a source virtual world (i.e., from where an avatar is teleported) and a state for a destination virtual world (i.e., to where an avatar is teleported) may change, in accord with the avatar changing its presence from the source virtual world to the destination virtual world by means of the “teleport”.

Virtual worlds may be hosted by the same or different vendors, and scenes in the virtual worlds and underlying engines (i.e., technologies that support the virtual worlds; e.g., OpenSimulator (an open source server for hosting virtual worlds—http://opensimulator.org/wiki/Main_Page), Torque Game Engine, etc.) may be homogeneous or heterogeneous. A technology to manage an end user's virtual assets to keep the end user's appearance and inventory the same in different virtual worlds (even in a current 2D web) is required.

Currently, different virtual worlds use different formats (e.g., a .DTS file format which is used with the Torque Game Engine) of 3D descriptions to represent virtual objects (e.g., avatar, building) in the different virtual worlds. This is a real issue when users try to teleport between different virtual worlds, and thus becomes an obstacle that prevents a user from providing a unified appearance and inventory to his/her friends in the virtual worlds. In addition, there is a need for users to share their virtual properties with other users across different worlds. End users also need to log in each different virtual world to manage their virtual assets in each different virtual world separately.

Thus, it would be desirable to provide a system and method for sharing and exchanging virtual objects across different virtual worlds.

### SUMMARY OF THE INVENTION

The present invention is a system and method for sharing and exchanging virtual objects across different virtual worlds. The system and method may also be used for sharing and exchanging between a single virtual world.

In one embodiment, there is provided a system for sharing and exchanging virtual objects across different virtual worlds comprising:

a computer-implemented federation module for centrally managing the virtual objects from the different virtual worlds;

a virtual object repository for storing the virtual objects from the different virtual worlds and being connected to the federation module;

a computer-implemented cache management module for employing a cache policy to enforce data consistency of the virtual objects, when the virtual objects are shared across the different virtual worlds;

a computer-implemented virtual object management module for managing avatars, virtual assets associated with the avatars, the virtual objects and for managing relationships between avatars, the virtual assets, and the virtual objects;

a computer-implemented request dispatch module for receiving a request from a virtual world among the different virtual worlds, processing the request, and dispatching the request to a proper module among the modules;

a computer-implemented content transmission controller for managing data transmission associated with the virtual objects between the different virtual worlds; and

an computer-implemented event notification module for enabling a publish/subscribe mechanism in the different virtual worlds, virtual world clients, the federation module, the cache management module, the virtual object management module, the request dispatch module, and the content transmission controller.

In another embodiment, there is provided a method for sharing and exchanging virtual objects across different virtual worlds comprising:

storing the virtual objects from the different virtual worlds;

centrally managing the virtual objects from the different virtual worlds;

employing a cache policy to enforce data consistency of the virtual objects, when the virtual objects are shared across the different virtual worlds;

managing avatars, virtual assets associated with the avatars, and the virtual objects and managing relationships between the avatars, the virtual assets, and the virtual objects;

receiving a request from a virtual world among the different virtual worlds, processing the request, and dispatching the request;

managing data transmission associated with the virtual objects between the different virtual worlds; and

enabling a publish/subscribe mechanism in the different virtual worlds, virtual world clients, the storing, the centrally managing, the employing, the managing, the receiving, the managing data transmission.

In one embodiment, the present invention proposes a distributed and shared system that stores or aggregates virtual asset of users. The system enables shared appearances of virtual objects and enables sharing virtual objects across different virtual worlds (even 2D web). In another embodiment, there are methods to download/upload, share, modify, and teleport virtual objects.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 illustrates a system diagram of one embodiment of the present invention.

FIG. 2 illustrates a flow diagram that depicts fetching a virtual object from an inventory service.

FIG. 3 illustrates a flow diagram that depicts uploading a virtual object to an inventory service.

FIG. 4 illustrates a flow diagram for sharing a virtual object with other avatars.

FIG. 5 illustrates a flow diagram for modifying a shared virtual object.

FIG. 6 illustrates a flow diagram for teleporting a virtual object from a virtual world to another virtual world through an inventory service.

FIG. 7 illustrates a flow diagram for teleporting a virtual object from a virtual world to another virtual world directly.

FIG. 8 illustrates a flow diagram for managing virtual objects and relationship between them by a virtual object management module.

### DETAILED DESCRIPTION

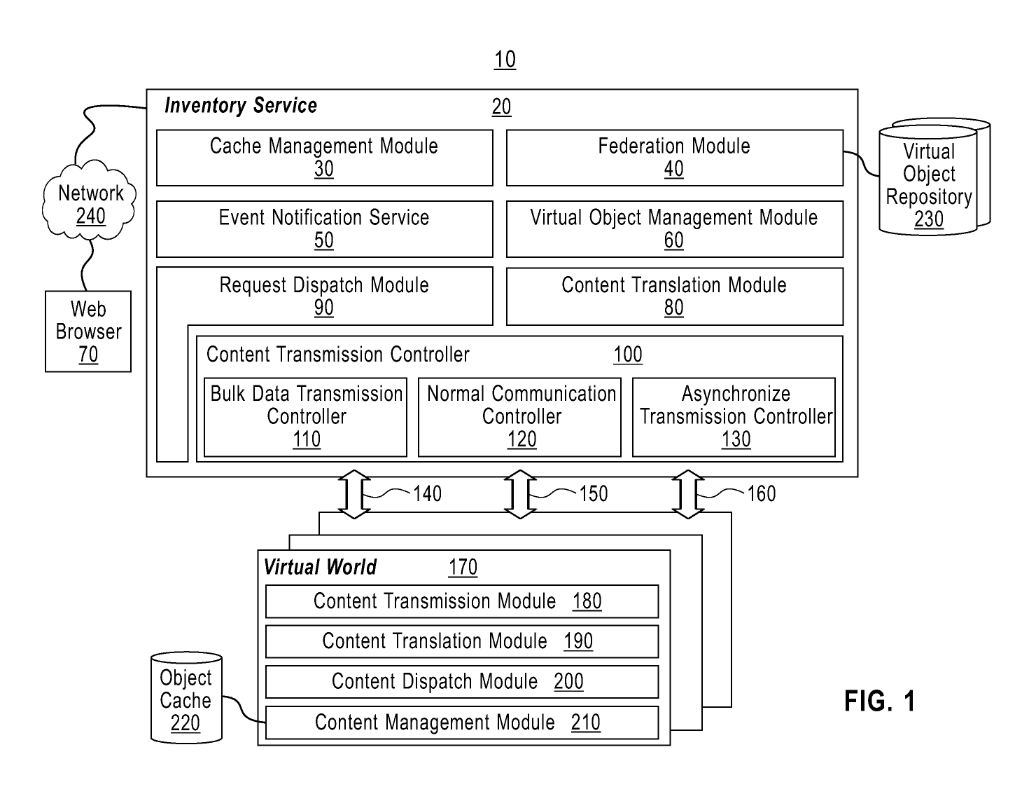

FIG. 1 illustrates a system diagram of one embodiment of the present invention. In an environment 10, a user can share and exchange virtual objects across different virtual worlds. In the environment 10, there is an inventory service 20 and at least one virtual world 170. The inventory service 20 allows the exchange and sharing of virtual objects across different virtual worlds, both for a single user and for multiple users. A virtual object refers to an avatar, a virtual product, a virtual building, a virtual weapon, a virtual power, a virtual authority, etc. A virtual object may include attributes and/or metadata to represent its properties such as its owner and relationship with other virtual objects. The virtual object may be represented by 2D image or 3D image. The inventory service 20 allows virtual objects that are stored in one format (e.g., DTD (Document Type Description) format) in a virtual world to be used in another format (e.g., X3D format (ISO standard XML-based file format for representing 3D computer graphics)) in another virtual world. For that purpose (i.e., format transformation of virtual objects), the inventory service 20 also stores virtual objects that are owned by a user, together with associated additional metadata (e.g., name of the virtual objects, file types of the virtual objects, owner(s) of the virtual objects) and state information (e.g., whether the virtual object has been changed or modified since being created). In one embodiment, the inventory service 20 is a separate and independent entity from virtual world computing environments 170, or is located on a same physical server. In another embodiment, the inventory service 20 is embedded in each virtual world 170.

The inventory service 20 includes a federation module 40, a cache management module 30, an event notification module 50, a virtual object management module 60, a request dispatch module 90, and a content transmission controller 100. In one embodiment, the inventory service 20 further includes a content translation module 80.

The federation module 40 is a module to unite or collect virtual objects from different virtual worlds, In one embodiment, the federation module 40 is connected to a virtual object repository 230 where virtual objects from the different virtual worlds are stored. In one embodiment, the virtual object repository is a storage device such as a magnetic disk, hard disk, solid state drive, optical storage device, direct access storage device, etc. The federation module 40 enables the inventory service 20 to centrally manage all the virtual objects from the different virtual worlds. In one embodiment, the federation module 40 centrally manages virtual objects from the different virtual worlds. The management tasks of the federation module 40 include, but are not limited to: enumerating all virtual objects in a virtual object repository 230, querying metadata and state of virtual object(s) to the virtual object repository 230 and deleting virtual object(s) in the virtual object repository 230.

A cache management module 30 together with a content management module 210 in a virtual world 170 manages virtual objects in virtual worlds as a distributed cache system (i.e., each virtual world 170 includes each local cache memory 220). The content management module 210 manages virtual objects locally in virtual world. Before virtual objects are used or accessed, the virtual objects are fetched from a local cache memory (e.g., an object cache 220) first. If the virtual objects are not found in the local cache memory, the virtual objects are fetched from local cache memories in other virtual worlds or the cache management module 30 in the inventory service, which utilizes one or more cache policies. Synchronization of contents in the local caches is maintained by the cache management module 30. When virtual objects are shared across different virtual worlds, the cache management module 30 employs a certain cache policy to enforce data consistency (i.e., for a shared virtual object, same metadata or attributes of the shared virtual object is maintained in the local caches across the different virtual worlds) of the shared virtual objects. For example, if a deletion action of a virtual object is permitted and a virtual object is deleted in a virtual world, then the deletion action triggers a notification (i.e., a message indicating the virtual object is deleted in a virtual world). The notification is then broadcasted over a network (e.g., Internet) or via a protocol (e.g., HTTP, UDP (User Datagram Protocol)) to other virtual worlds that maintain the virtual object in local cache memories. Upon reception of the notification, local cache memories (e.g., a local cache memory 220) immediately invalidate an entry for the virtual object by flagging it as invalid. Furthermore, the entry may be deleted from the cache memories according to a cache policy. An attempt to access the virtual object in the local cache memories results in exceptions. A cache policy that the cache management module 30 employs includes, but is not limited to, MSI (Modified, Shared, and Invalid states) protocol, MESI (Modified, Exclusive, Shared, and Invalid states) protocol, MOESI (Modified, Owned, Exclusive, Shared, and Invalid states) protocol, Write-once protocol, Synapse protocol, Berkeley protocol, Illinois protocol, Firefly protocol, and Dragon protocol. Paul Sweazey, et al. “A Class of Compatible Cache Consistency Protocols and their Support by the IEEE Futurebus”, 1986 IEEE, which is wholly incorporated as reference herewith, describes these cache policies in detail.

An event notification module/service 50 enables a publish/subscribe mechanism in virtual worlds, virtual world clients, and modules (e.g., a cache management module 30, a federation module 40, a virtual object management module 60, a request dispatch module 90, a content translation module 80, and a content transmission controller 100) in the inventory service 20. In the publish/subscribe mechanism, any number of consumers of information can receive messages that are provided by one or more producers of that information. A producer of information is called a publisher and a consumer of that information is called subscriber. The publish/subscribe mechanism provides a concept of a topic on which any number of interested consumers of information can subscribe in order to register their interest. This is similar to the way that a person might subscribe only to magazine about topics in which they are interested. Each topic provides particular event or state information. A publisher can send messages containing information about a particular topic to all subscribers to that topic, without any knowledge of how many subscribers there are, or the details of the nodes that host those subscribers. Because of this, publish/subscribe mechanism completely decouples the provider of the information from the consumer of that information. Returning to FIG. 1, in one embodiment, the event notification module/service 50 provides services to modules in the inventory service 20, virtual worlds, and virtual world clients. The services includes, but is not limited to, subscribing a topic, unsubscribing a topic, notifying (e.g., notifying upon receiving a message related to a topic), registering to a publisher interface (i.e., an API (Application Programming Interface) interface used by publisher to publish information), and un-registering from publisher interfaces. In one embodiment, the event notification service/module 50 is a broker (i.e., a component to which application (e.g., virtual worlds, modules in the inventory service 20) connect to perform publish and subscribe information). Through the event notification module/service 50, virtual worlds, virtual world clients, and modules in the inventory service 20 can register as publishers or act as subscribers for information (e.g., a virtual object status change or a virtual object modification) that they are interested in.

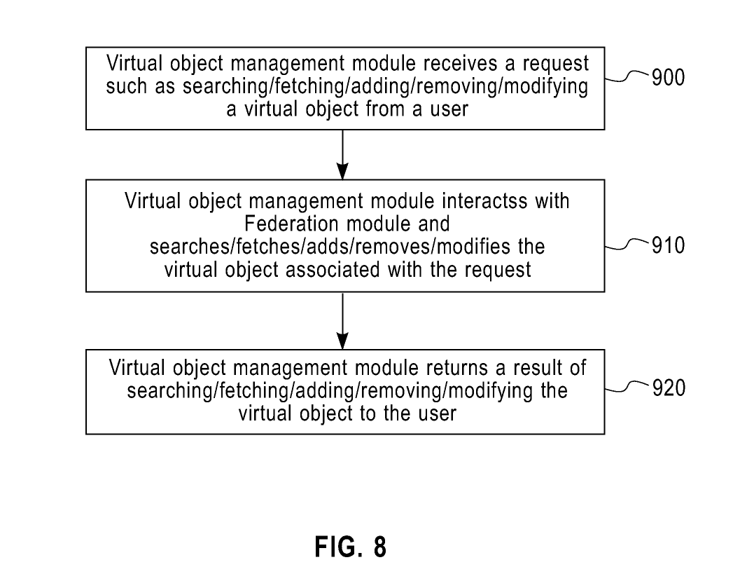

A virtual object management module 60 manages avatars, virtual assets associated with the avatars, and virtual objects within the inventory service 20 and manages relationships between the avatars, the virtual assets, and the virtual objects. The virtual object management module 60 interacts with the federation module 40 to provide a function of virtual object management, which includes but is not limited to: searching virtual objects in the virtual object repository 230, fetching virtual objects from the virtual object repository 230, adding virtual objects into the virtual object repository 230, removing virtual objects from the virtual object repository 230, modifying properties of virtual objects such as metadata or attributes modification of the virtual objects, ownership changes of the virtual objects and relationship changes between the virtual objects and other objects. Relationship may refer to a relative size and position between virtual objects. Virtual objects may be attached or combined together to form a complex virtual object. FIG. 8 describes method steps that the virtual object management module 60 may execute. At step 900, the virtual object management module 60 receives a request such as searching, fetching, adding or modifying a virtual object from a user, who is connected to a network 240, to which the inventory service 20 is also connected, and operates a computing device (not shown) including a web browser 70 to be connected to the network 240. At step 910, the virtual object management module 60 interacts with a federation module 40 and executes the request such as searching, fetching, adding, removing and modifying the virtual object associated with the request. At step 920, the virtual object management module 60 returns a result of executing the request to the user. For example, if the request was searching a virtual object, the result of searching may be a Boolean value indicating “found” or “not found”. If the request was fetching a virtual object, the result of fetching may the fetched virtual object or an error message indicating the corresponding virtual object cannot be retrieved. If the request was adding a virtual object, the result of adding may be a Boolean value indicating “successfully added into the virtual object repository 230” or “failure in an attempt to add the virtual object into the virtual object repository 230”. If the request was modifying a virtual object, the result of modifying may be a Boolean value indicating “successfully modified” or “failure in an attempt to modify the virtual object”.

Returning to FIG. 1, a content translation module 80 translates a data format (e.g., .DTS file format) of a virtual object from one type to another. For example, the content translation module 80 translates 3D object description of a virtual object from .X3D file format to .DTS file format and/or from .DTS file format to .X3D file format. The content translation module 80 exists either in the inventory service 20 or a virtual world 170. In one embodiment, the content translation module 80 exists in the inventory service 20 and a virtual world 170. In another embodiment, the content translation module 80 does not exist either in the inventory service 20 or a virtual world 170. The content translation module 80 in the inventory service 20 may be invoked by a request dispatch module 90. The request dispatch module 90 is described in detail later. The content translation module 80 may be invoked for a transmission, where a target format does not match a source format. For example, a user requests a transmission of a virtual object from the inventory service 20 in DTS format. However, the virtual object repository 230 may store virtual objects in X3D format. In this example, before the content translation module 80 provides the virtual object to the user, the content translation module 80 transforms the virtual object from X3D format to DTD format.

A request dispatch module 90 receives requests from virtual worlds or a web site via a network (e.g., Internet) 240 to which a computing device (not shown) including a web browser 70 is actively connected. Then, the request dispatch module 90 processes the requests, and dispatches the requests into a proper module (e.g., a virtual object management module 60) as implemented within the inventory service 20.

A content transmission controller 100 “manages” data transmission associated with virtual objects between virtual worlds and the inventory service 20. In one embodiment, a content transmission controller 100 “manages” data transmission associated with virtual objects between virtual worlds. In one embodiment, the content transmission controller 100 comprises a bulk data transmission controller 110, an asynchronize transmission controller 130, and a normal transmission controller 120. The bulk data transmission controller 110 “manages” large data transmission (e.g., avatar 3D module downloading and uploading) associated with a virtual object between virtual worlds. In one embodiment, the bulk data transmission controller 110 “manages” large data transmission (e.g., avatar 3D module downloading and uploading) associated with a virtual object between virtual worlds and the inventory service 20. The large data transmission is used when a major context switching in an application happens (e.g., when a user teleports from one virtual world to another virtual world). Large data refers to the number of virtual objects that have to be transmitted, not to the amount of data associated with virtual objects. In one exemplary embodiment, if more than 10% of total virtual objects in the virtual object repository 230 have to be transmitted, then the large data transmission may be used. The bulk data transmission controller 110 may utilize HSTCP (High-Speed TCP) protocol or bulk data transfer protocol. The asynchronize transmission controller 130 “manages” asynchronous message transmission associated with a virtual object between virtual worlds. In one embodiment, the asynchronize transmission controller 130 “manages” asynchronous message transmission associated with a virtual object between virtual worlds and the inventory service 20. The normal transmission controller 120 “manages” other types of messages (e.g., a request, a small data transmission) associated with a virtual object between virtual worlds. In one embodiment, the normal transmission controller 120 “manages” other types of messages (e.g., a request, a small data transmission) associated with a virtual object between virtual worlds and the inventory service 20. The small data refers to the number of virtual objects that have to be transmitted. If less than or equal to 10% of total virtual objects in the virtual object repository 230, then the normal transmission controller 120 may be used. The asynchronize transmission controller 130 and the normal transmission controller 120 may utilize HTTP protocol, TCP/IP protocol, UDP protocol, etc. In this context associated with a content transmission controller 100, “manage” may refer to a function of: addressing a target (e.g., IP address, port number or other method to locate a target machine), initializing data transmission (e.g., setting the target machine into a state for receiving data), formatting data (i.e., putting data into TCP/IP packet body), committing a transmission (i.e., performing the transmission), and/or finalizing the transmission (e.g., closing a communication channel upon a transmission completion or reserving a communication channel for later transmission).

In one embodiment, the modules (e.g., a cache management module 30, a federation module 40, an event notification service/module 50, a virtual object management module 60, a request dispatch module 90, a content translation module 80) and controllers (e.g., content transmission controller 100) in the inventory service 20 are used for sharing and exchanging virtual objects within identical virtual world(s). In a further embodiment, the modules in the inventory service 20 are used for a separate state management of virtual objects within the identical virtual world(s). In this embodiment, the virtual object management module 60 separately manages a shared virtual object and/or an exchanged virtual object per each avatar associated with the shared virtual object and/or the exchanged virtual object. For example, a virtual phone is shared between two different avatars, e.g., a first avatar and a second avatar. The virtual object management module 60 enables each avatar to enter different contact list(s) or direct dial number(s) in the virtual phone. However, the different contact list(s) and direct dial number(s) may not be shared between the two different avatars. Thus, when the first avatar accesses the virtual phone, the virtual object management module 60 configures the virtual phone to activate contact list(s) and/or direct dial number(s) associated with the first avatar. If the second avatar accesses the virtual phone, the virtual object management module 60 configures the virtual phone to activate contact list(s) and/or direct dial number(s) associated with the second avatar.

In one embodiment, the modules (e.g., a cache management module 30, a federation module 40, an event notification service/module 50, a virtual object management module 60, a request dispatch module 90, a content translation module 80) and controllers (e.g., content transmission controller 100) in the inventory service 20 are implemented as hardware through a computing device. The computing device comprises a central processing unit (CPU), memories, secondary storage devices, input/output devices, network connectors, a CD-ROM drive, etc. The all the modules in the inventory service 20 may comprise methods, programs, instructions stored in the memories and executed by the CPU.

The virtual world 170 includes a content transmission module 180, a content dispatch module 200, and a content management module 210. In one embodiment, the virtual world 170 further includes a content translation module 190. The content transmission module 180 manages data transmission associated with a virtual object between different virtual worlds. In one embodiment, the content transmission module 180 manages data transmission associated with a virtual object between different virtual worlds and the inventory service 20. In one embodiment, the content transmission module 180 manages a bulk data transmission channel (e.g., a channel for downloading or uploading avatar 3D module), an asynchronous message transmission channel, and normal transmission channel (e.g., a channel for a request delivery or a small data transmission). The bulk data transmission channel corresponds to the bulk data transmission controller 110 and performs the same tasks as it. The asynchronous message transmission channel corresponds to the asynchronous transmission controller 130 and performs the same tasks as it. The normal transmission channel corresponds to the normal transmission controller 120 and performs the same tasks as it.

In one embodiment, the virtual world 170 includes a content translation module 190. As like the content translation module 80 in the inventory service, the content translation module 190 translates a data format (e.g., .DTS file format) of a virtual object from one type to another for compatible execution on other user's computing environments. A content dispatch module 200 statically or dynamically dispatches messages between virtual worlds and the inventory service 20 via the three transmission channels (e.g., a bulk data transmission channel, an asynchronous message transmission channel, and normal transmission channel). In one embodiment, the content dispatch module 200 statically or dynamically dispatches messages between virtual worlds via the three channels. In one embodiment, there is no content dispatch module 200 in the virtual world 170. Instead, dispatching information (e.g., which channel will be used for delivering a message) is statically embedded into a message. For example, 3D data transmission message is dispatched from the virtual world 170 to the inventory service 20 over the bulk transmission channel. A request to fetch virtual object description is dispatched over the normal transmission channel. An object change status change notification (e.g., a message indicating a shared virtual object is modified) dispatched for a communication over the asynchronous transmission channel.

A content management module 210 manages virtual objects, which are located at virtual worlds, locally. The content management module 210 also manages data consistency of virtual objects between different virtual worlds. In one embodiment, a virtual world 170 maintains a local cache memory 220 where virtual objects and other information downloaded from inventory service 20 are stored. The local cache memory 220 is connected to the content management module 210. The content management module 210 maintains data consistency of virtual objects between different local cache memories by utilizing cache policies such as MOESI or firefly protocol.

In one embodiment, all modules in the virtual world 170 are implemented in hardware through a computing device. The computing device comprises a central processing unit (CPU), memories, secondary storage devices, input/output devices, network connectors, a CD-ROM drive, etc. The all the modules in the virtual world 170 may comprise methods, programs, instructions stored in the memories and executed by the CPU.

In another embodiment, J2EE (Jave 2 Platform, Enterprise Edition) is integrated in the virtual world 170 and the inventory service 20 to manage, modify, browse, and query virtual objects centrally. In this embodiment, a web browser 70 accesses the inventory service 20 directly via HTTP protocol.

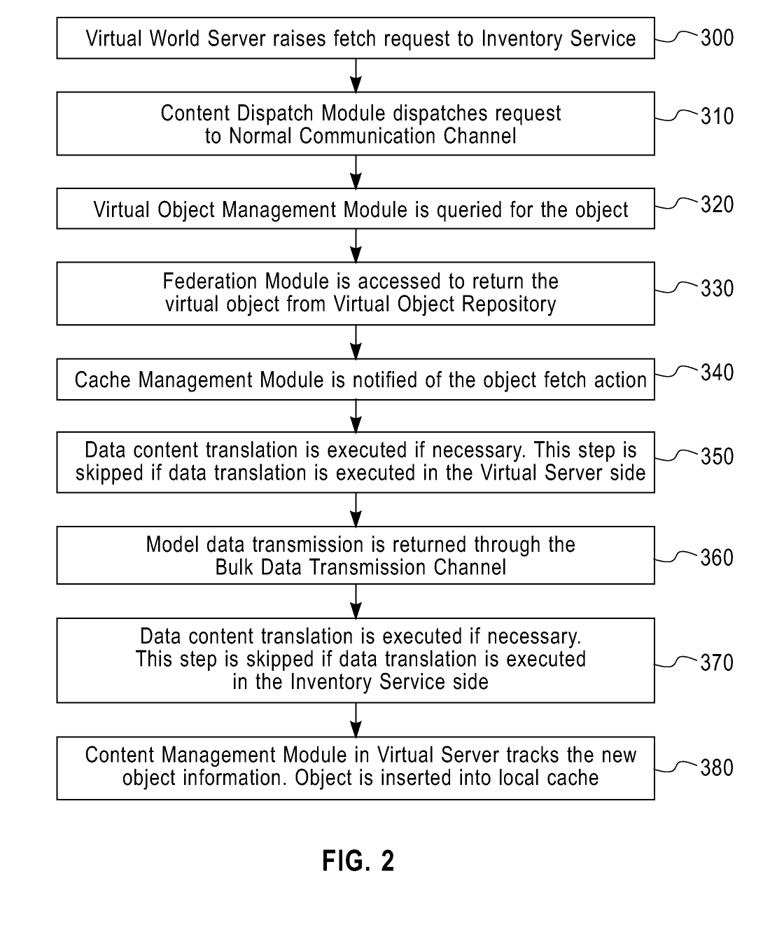

FIG. 2 illustrates fetching a virtual object from the inventory service 20 to the virtual world 170. For example, an avatar in a virtual world may want to use virtual objects in the inventory service 20's virtual object repository 230. Specifically, the avatar may want to receive the virtual objects from the virtual object repository 230 in order to instantiate the virtual objects in 3-dimensional space of the virtual world. Then, at step 300, a virtual world server (e.g., OpenSimulator) associated with the avatar raises a virtual object fetching request to the inventory service 20. At step 310, the content dispatch module 200 dispatches the request to the normal transmission channel in the content transmission module 180. At step 320, the content transmission controller 100 in the inventory service 20 receives the request and sends the request to the request dispatch module 90. The request dispatch module 90 dispatches the request to the virtual object management module 60. The virtual object management module 60 is queried by the request dispatch module 90 for the virtual object specified in the request. At step 330, the federation module 40 is accessed to retrieve the virtual object and information (e.g., 2D or 3D data model, description) related to the virtual object. In one embodiment, the federation module 40 is accessed to retrieve the virtual object from the virtual object repository 230. At step 340, the cache management module 30 in the inventory service 20 tracks the virtual object downloading event. In one embodiment, the cache management module 30 tracks the start of the downloading event. The downloading event may result in some data being cached in the virtual world 170. Depending to a cache policy implemented, there may be some data transmission caused by the downloading event between the inventory service 20 and the virtual world 170.

At step 350, the content translation module 80 in the inventory service 20 performs data content translation if necessary. The step 350 may be skipped if data content translation is executed in the virtual world 170. At step 360, a data model (e.g., data and/or instructions for 3D virtual object's representation (3D geometry, 3D texture, etc) or a machine readable description that can be rendered in the virtual world 170) of the virtual object is sent through the bulk data transmission controller 110 in the inventory service 20. The data model of the virtual object is received in the virtual world 170 through a bulk data transmission channel in the content transmission module 180. At step 370, the content translation module 190 in the virtual world 170 performs data translation if necessary. The step 370 may be skipped if data content translation is executed in the inventory service 20. At step 380, the data model of the virtual object is entered into a local cache memory 220 in the virtual world 170. The content management module 210 in the virtual world 220 tracks a status of the virtual object.

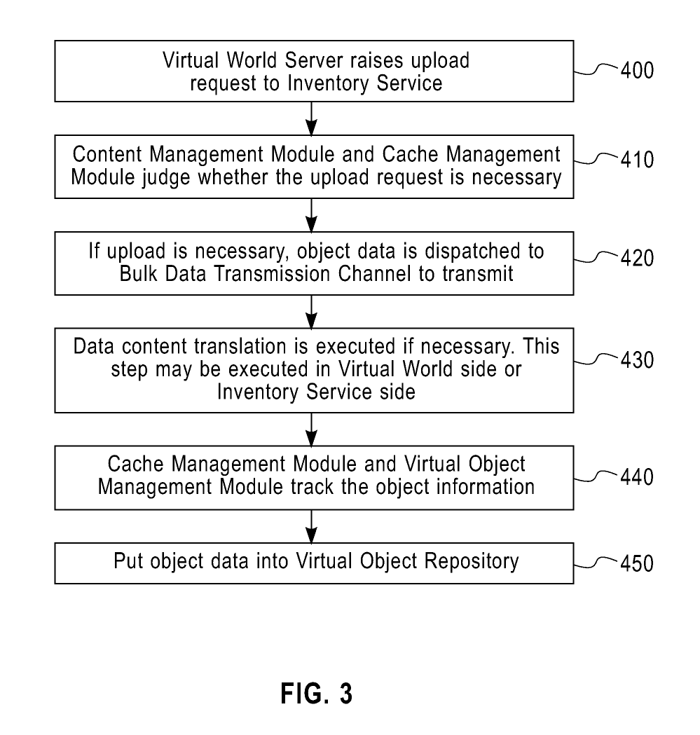

FIG. 3 illustrates method steps for uploading a virtual object from the virtual world 170 to the inventory service 20. At step 400, the virtual world 170 raises a virtual object uploading request to the inventory service 20. At step 410, the content management module 210 and the cache management module 30 determines whether the uploading request is necessary. In one embodiment, it is checked whether there is a modification on the virtual object associated with the uploading request. If there is no modification on the virtual object (e.g., the inventory service 20 has the up-to-date data model of the virtual object), the uploading request is not accepted. At step 420, if it is determined that the uploading request is necessary (e.g., there has been a modification on the virtual object since last uploading to the inventory service 20), the content dispatch module 200 dispatches the virtual object to a proper transmission channel (e.g., a bulk data transmission channel) in the content transmission module 180. At step 430, data translation is performed if necessary. The data translation can be performed in the data translation module 180 in the virtual world 170 before the transmission. The data translation can be performed in the data translation module 80 in the inventory service 80, after the virtual object is transmitted to the inventory service 20.

At step 440, the cache management module 30 and the virtual object management module 60 track an uploading event of the virtual object. In one embodiment, the cache management module 30 and the virtual object management module 60 track a start of the uploading event. After the uploading is completed, the uploaded virtual object is placed in the inventory service's virtual object repository 230 through the federation module 40.

In one embodiment, the present invention supports a login process to the virtual world. A user provides an identification (ID) and a password to login through the web browser 70. After the ID and password are verified or a user authentication process (e.g., checking whether the user is a registered user based on the provided ID and password) is passed, a default data (e.g., the user's avatar) is fetched from the inventory service 20 to the virtual world 170. Then, a virtual world server (e.g., a server for hosting the virtual world 170) associated with the virtual world 170 subscribes to the event notification service 50 in the inventory service 20 to receive messages or notifications related to the user's avatar's shared virtual objects and/or register to the publisher's interface (e.g., an API used by publisher in the publish/subscribe mechanism to publish information through messages or notifications).

In one embodiment, the present invention supports a logout process from the virtual world. After a user decides to logout from the virtual world 170, virtual objects (e.g., avatar) associated with the user are uploaded to the inventory service 20 from the virtual world 170. After completing the uploading, the virtual objects in the local cache memory 220 are deleted or cleaned up. Then, a virtual world server (e.g., a server for hosting the virtual world 170) associated with the virtual world 170 communicates with the event notification service 50 in the inventory service 20 to un-subscribe messages or notifications related to shared virtual objects of the user's avatar.

In one embodiment, the content dispatch module 200 in the inventory service 20 manages messages statically or dynamically. For example, messages related to a virtual object (e.g., avatar or virtual assets associated with an avatar) status or data model changes (e.g., changes in 3D representation or a machine readable description) are dispatched for a communication over an asynchronous transmission channel (not shown) in the content transmission channel 180. Messages related to a virtual object data model transmission (e.g., transmission of 3D representation or a machine readable description of the virtual object) is dispatched to a bulk data transmission channel in the content transmission channel 180. Messages related to other data transmission (e.g., a small data transmission) is dispatched over a normal transmission channel (not shown) in the content transmission channel 180.

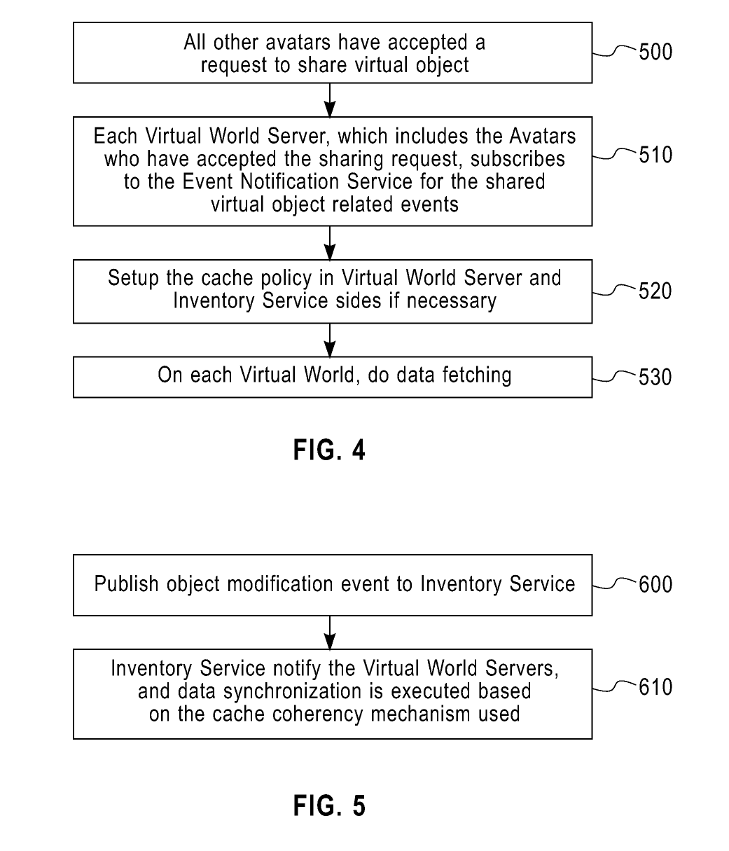

FIG. 4 illustrates method steps for sharing virtual objects with other avatars. Sharing a virtual object means that there is a single instance of a virtual object which is available for use of a first avatar and a second avatar. However, the single instance of the virtual object can only be used in one virtual world at a time. When a need arises to use the virtual object in a virtual world, there is a sequence of state update of the virtual object in the inventory service 20's virtual object repository 230. The inventory service 20 first deletes an instance of the virtual object in a first virtual world. Then, a status of the virtual object is set in the inventory service 20 to be available for an instantiation in another virtual world and only then can the virtual object be transmitted and available in the second virtual world. Method steps in FIG. 4 describe this sharing a virtual object in detail. At step 500, an avatar submits a request to share his/her virtual objects with other avatars through a normal transmission channel in the content transmission channel 180. Other avatars associated with the request approve the request for sharing virtual objects. At step 510, virtual world servers where the avatars reside in subscribe to the event notification service 50 in the inventory service 20 to receive topic notifications (e.g., messages related to a shared virtual object's creation, deletion, modification, owner change, etc.) on the shared virtual objects. At step 520, the cache management module 30 in the inventory service 20 and the content management module 210 in the virtual world(s) 170 set a cache policy for local cache memories 220. At step 530, based on the cache policy, data consistency of shared virtual objects is maintained (e.g., by fetching up-to-date shared virtual objects in the local cache memories 220). In one embodiment, the avatars sharing their virtual objects reside in different or heterogeneous virtual worlds. In another embodiment, the avatars sharing virtual objects reside in a same or homogeneous virtual world.

In one embodiment, the present invention supports removing virtual object sharing with other avatars (e.g., an original owner of a shared virtual object does not want to share the virtual object any more). In this embodiment, an avatar raises a request for stopping sharing his/her virtual objects. Then, virtual world severs where other avatars reside in communicate to the event notification service 50 to un-subscribe topic notifications related to shared virtual objects of the avatar that requested stopping his/her virtual object sharing. To maintain data consistency, after un-subscribing the topic notifications, virtual worlds except a virtual world where the avatar, which requested stopping his/her virtual object sharing, resides in can delete the shared virtual objects from local cache memories. In one embodiment, to remove a shared virtual object from sharing, the inventory service 20 stops sending topic notifications related to the shared virtual object to virtual world servers. Before removing a shared virtual object from sharing, data uploading (e.g., uploading the shared virtual object from a virtual world 170 to the inventory service 20), data fetching (e.g., updating the inventory service 20 with an up-to-date data model of the shared virtual object) and data deleting (e.g., deleting the shared virtual object in local cache memories in virtual worlds) may be performed to maintain data consistency of the shared virtual object.

In one embodiment, the present invention supports terminating sharing virtual object(s) of other avatars. For example, a second avatar, which had approved a request of sharing virtual objects of the first avatar, does not want to share the virtual objects of the first avatar any more. Then, the virtual world server associated with the second avatar communicates to the event notification service 50 in the inventory service 20 to un-subscribe topic notifications related to the virtual objects of the first avatar. Before quitting from sharing virtual objects of the first avatar, data uploading (e.g., uploading the shared virtual object from a virtual world where the second avatar resides in to the inventory service 20), data fetching (e.g., updating the inventory service 20 with an up-to-date data model of the virtual objects) and data deleting (e.g., deleting the virtual objects of the first avatar in the local cache memory in the virtual world where the second avatar resides in) may be performed to maintain data consistency of the virtual objects of the first avatar.

In one embodiment, the present inventions supports accessing a shared virtual object. When a virtual world client (e.g., a registered user for a virtual world) wants to access a shared virtual object, it is checked whether the shard virtual object has been modified since last access by the virtual world client. In one embodiment, each local cache memory has an entry per a virtual object. The entry indicates whether the virtual object associated with entry is valid (e.g., whether it is up-to-date) or not. If the shared virtual object has not been modified, an access to the shared virtual object is granted. However, if the shared virtual object has been modified, an up-to-date data model (e.g., 3D representation or machine readable description) of the shared virtual object is transferred from other virtual world servers that store the up-to-date data model of the shared virtual object via a bulk data transmission channel. In another embodiment, if the shared virtual object, which has been requested to access, has been modified, the inventory service 20 is notified to fetch an up-to-date data model of the shared virtual object from other servers which has a valid entry associated with the shared object in local cache memories. Then, the inventory service 20 transmits the up-to-date data model of the shared virtual object to the virtual world client who requested accessing the shared virtual object or to a virtual world server associated with the virtual world client who requested accessing the shared virtual object.

FIG. 5 illustrates method steps for modifying a shared virtual object. When a shared virtual object is modified, a virtual world sever associated with the modification sends a topic notification (e.g., an object modification event) to the inventory service 20. Then the inventory service 20 notifies virtual world servers associated with the shared virtual object (e.g., by forwarding the topic notification). Based on a cache policy, data synchronization and transmission (e.g., transmitting an up-to-date data model of the modified shared virtual object) may occur to maintain data consistency of the shared virtual object.

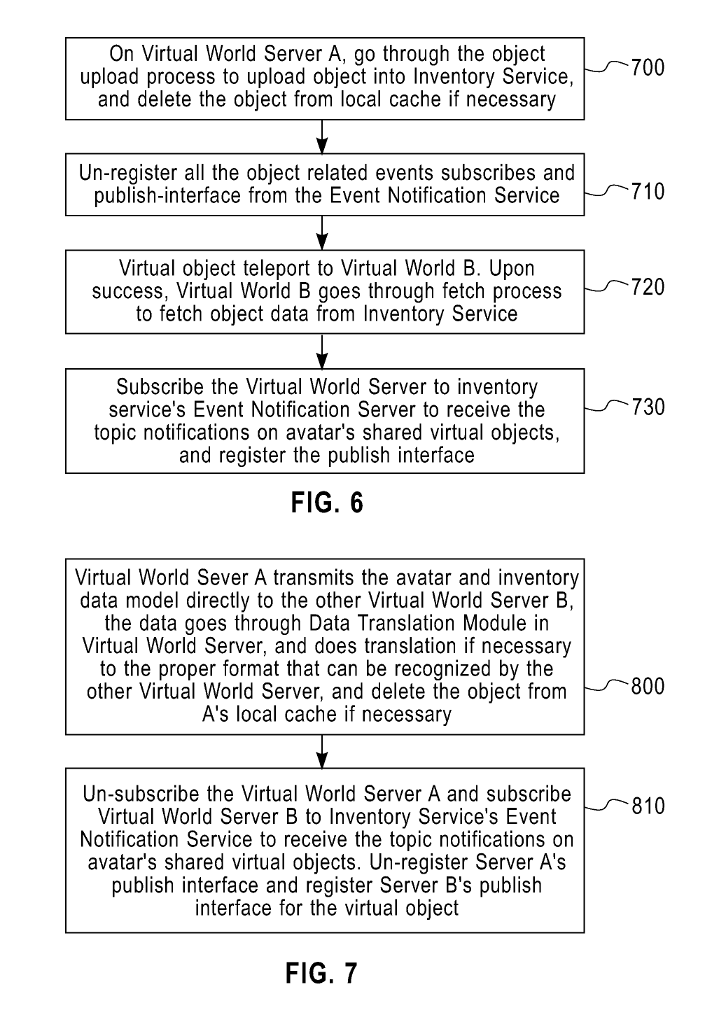

FIG. 6 illustrates method steps for teleporting (e.g., roaming) an avatar and the avatar's virtual assets from a virtual world (e.g., a virtual world C) to another virtual world (a virtual world D). At step 700, a virtual world server A transmits an avatar and the avatar's virtual assets to the inventory service 20, if there has been any modification on the avatar and the virtual assets since last uploading to the inventory service 20. Data translation may be performed before the transmitting via the content translation module 190 in the virtual world 170 or after the transmitting via the content translation module 80 in the inventory service 20. The avatar and the virtual assets may be deleted from a local cache memory in the virtual world server A.

At step 710, the virtual world server A communicate with the event notification service 50 in the inventory service 20 to un-subscribe topic notifications related to shared virtual objects of the avatar. In addition, the virtual world server A unregisters from a publisher interface related to the shared virtual objects of the avatar. At step 720, when the avatar and the virtual assets are successfully teleported from the virtual world C to the virtual world D, the virtual world server B associated with the virtual world D downloads the avatar and the virtual assets from the inventory service 20 via a bulk data transmission channel. Data translation may be performed before the downloading via the content translation module 80 in the inventory service 20 or after the downloading via the content translation module 190 in the virtual world 170.

At step 730, the virtual world server B communicates with the event notification service 50 in the inventory service 20 to subscribe topic notifications related to shared virtual objects of the avatar that just teleported from the virtual world C to the virtual world D. The virtual world server B further registers to a publisher interface related to the shared virtual objects.

FIG. 7 illustrates method steps for teleporting an avatar and the avatar's virtual assets directly from a virtual world (e.g., a virtual world C associated with a virtual world server A) to another virtual world (e.g., a virtual world D associated with a virtual world server B). At step 800, a virtual world server A transmits an avatar and the virtual assets directly to a virtual world server B. Data translation (e.g., transforming a virtual object from .DTS file format to .X3D file format) may be performed in the virtual world server A before transmitting or may be performed in the virtual world server B after transmitting. The data translation ensures that the avatar and the virtual assets are converted to a proper format that can be recognized by the virtual world server B. After transmitting the avatar and the virtual assets, the avatar and the virtual assets may be deleted from a local cache memory in the virtual world server A.

At step 810, the virtual world server A communicates with the event notification service 50 in the inventory service 20 to un-subscribe topic notifications related to shared virtual objects of the avatar. In addition, the virtual world server A unregisters from a publisher interface related to the shared virtual objects of the avatar. The virtual world server B communicates with the event notification service 50 in the inventory service 20 to subscribe topic notifications related to the shared virtual objects of the avatar. The virtual world server B further registers to a publisher interface related to the shared virtual objects.

Although the preferred embodiments of the present invention have been described in detail, it should be understood that various changes and substitutions can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art

What is claimed is:

1. A system for sharing and exchanging virtual objects across different virtual worlds comprising:
a computer-implemented federation module for centrally managing the virtual objects from the different virtual worlds;
a virtual object repository for storing the virtual objects from the different virtual worlds and being connected to the federation module;
a computer-implemented cache management module for employing a cache policy to enforce data consistency of the virtual objects, when the virtual objects are shared across the different virtual worlds;
a computer-implemented virtual object management module for managing avatars, virtual assets associated with the avatars, the virtual objects and for managing relationships between avatars, the virtual assets, and the virtual objects;
a computer-implemented request dispatch module for receiving a request from a virtual world among the different virtual worlds, processing the request, and dispatching the request to a proper module among the modules;
a computer-implemented content transmission controller for managing data transmission associated with the virtual objects between the different virtual worlds; and
an computer-implemented event notification module for enabling a publish/subscribe mechanism in the different virtual worlds, virtual world clients, the federation module, the cache management module, the virtual object management module, the request dispatch module, and the content transmission controller.

2. The system according to claim 1, wherein the content transmission controller further comprising:
a computer-implemented bulk data transmission controller for managing large data transmission associated with the virtual objects between the different virtual worlds.

3. The system according to claim 1, wherein the content transmission controller further comprising:
a computer-implemented asynchronize transmission controller for managing an asynchronous message transmission associated with the virtual objects between the different virtual worlds.

4. The system according to claim 1, wherein the content transmission controller further comprising:
a computer-implemented normal transmission controller for managing a request and a small data transmission associated with the virtual objects between the different virtual worlds.

5. The system according to claim 1, further comprising:
a computer-implemented content translation module for translating a data format of the virtual objects from one type to another type.

6. The system according to claim 5, wherein the computer-implemented content translation module is located at the different virtual worlds.

7. The system according to claim 1, wherein the cache policy comprising one or more of: MSI (Modified, Shared, and Invalid states) protocol, MESI (Modified, Exclusive, Shared, and Invalid states) protocol, MOESI (Modified, Owned, Exclusive, Shared, and Invalid states) protocol, Write-once protocol, Synapse protocol, Berkeley protocol, Illinois protocol, Firefly protocol, and Dragon protocol.

8. The system according to claim 1, further comprising:
a computer-implemented content transmission module locating at the different virtual worlds and managing data transmission associated with the virtual objects between the different virtual worlds.

9. The system according to claim 1, further comprising:
a computer-implemented content dispatch module locating at the different virtual worlds and statically or dynamically dispatching messages between the different virtual worlds.

10. The system according to claim 1, further comprising:
a computer-implemented content management module located at the different virtual worlds, comprising a local cache memory in each different virtual world to store the virtual objects, managing the virtual objects locally in the each different virtual world, and managing data consistency of the virtual objects across the different virtual worlds.

11. The system according to claim 1, wherein the computer-implemented virtual object management module interacts with the computer-implemented federation module to provide one or more functions of: searching virtual objects in the virtual object repository, fetching virtual objects from the virtual object repository, adding virtual objects into the virtual object repository, removing virtual objects from the virtual object repository, and modifying properties of virtual objects.

12. The system according to claim 1, wherein the different virtual worlds are identical.

13. A method for sharing and exchanging virtual objects across different virtual worlds comprising:
storing the virtual objects from the different virtual worlds;
centrally managing the virtual objects from the different virtual worlds;
employing a cache policy to enforce data consistency of the virtual objects, when the virtual objects are shared across the different virtual worlds;
managing avatars, virtual assets associated with the avatars, and the virtual objects and managing relationships between the avatars, the virtual assets, and the virtual objects;
receiving a request from a virtual world among the different virtual worlds, processing the request, and dispatching the request;
managing data transmission associated with the virtual objects between the different virtual worlds; and
enabling a publish/subscribe mechanism in the different virtual worlds, virtual world clients, the storing, the centrally managing, the employing, the managing, the receiving, the managing data transmission.

14. The method according to claim 13, wherein the managing the virtual objects further comprises: searching the virtual objects in a virtual object repository, fetching the virtual objects from the virtual object repository, adding the virtual objects into the virtual object repository, removing the virtual objects from the virtual object repository, and modifying properties of the virtual objects.

15. The method according to claim 13, wherein the managing data transmission further comprises:
providing large data transmission associated with the virtual objects between the different virtual worlds via a bulk data transmission controller;
providing an asynchronous message transmission associated with the virtual objects between the different virtual worlds via an asynchronous transmission controller; and
providing a request and a small data transmission associated with the virtual objects between the different virtual worlds via a normal transmission controller.

16. The method according to claim 13, further comprising:
translating a data format of the virtual objects from one type to another type.

17. The method according to claim 16, wherein the translating is performed at the different virtual worlds.

18. The method according to claim 17, wherein the cache policy comprising one or more of: MSI (Modified, Shared, and Invalid states) protocol, MESI (Modified, Exclusive, Shared, and Invalid states) protocol, MOESI (Modified, Owned, Exclusive, Shared, and Invalid states) protocol, Write-once protocol, Synapse protocol, Berkeley protocol, Illinois protocol, Firefly protocol, and Dragon protocol.

19. The method according to claim 13, further comprising:
at different virtual worlds, managing data transmission associated with the virtual objects between the different virtual worlds.

20. The method according to claim 16, further comprising:
statically or dynamically dispatching messages between the different virtual worlds.

21. The method according to claim 17, further comprising:
managing the virtual objects locally in each different virtual world by providing a local cache memory in each different virtual world to store the virtual objects and maintaining data consistency of virtual objects across the different virtual worlds.

22. The method according to claim 13, wherein the different virtual worlds are identical.

23. A method for teleporting virtual objects from a first virtual world server to second virtual world server comprising:
transmitting the virtual objects directly from the first virtual world server to the second virtual world server;
translating the virtual objects to be a proper format that can be recognized by the second virtual world server;
deleting the virtual objects from a local cache in the first virtual world server; and
un-subscribing the first virtual world server and subscribing the second world server to an event notification service to receive notification associated with the virtual objects.

24. A program storage device readable by machine, tangibly embodying a program of instruction executable by the machine to perform method steps for sharing and exchanging virtual objects across different virtual worlds, the method steps comprising the steps of claim 13.
